(19) United States
(12) Patent Application Publication
(10) Pub. No.: US 2011/0246134 A1
(43) Pub. Date: Oct. 6, 2011

(54) Real Time Statistical Triggers on Data Streams

(75) Inventors: Leo D. FRISHBERG, Portland, OR (US); Timothy E. BIEBER, Portland, OR (US); Kyle L. BERNARD, Tigard, OR (US); Shigetsune TORIN, Beaverton, OR (US)

(73) Assignee: TEKTRONIX, INC., Beaverton, OR (US)

(21) Appl. No.: 13/078,224

(22) Filed: Apr. 1, 2011

Related U.S. Application Data
(60) Provisional application No. 61/321,064, filed on Apr. 5, 2010.

(51) Int. Cl. G06F 19/00

(52) U.S. Cl. 702/179

(57) ABSTRACT

Logic analyzers and real-time spectrum analyzers use real-time statistical processes as a basis for creating a trigger. The statistical displays within a test and measurement system such as a Logic Analyzer (LA) or Spectrum Analyzer (SA) or other instrument are used in a user interface to define a trigger based on the statistical event itself. In brief, the invention is a Real Time Statistical trigger established by the user through a direct interaction with the Real Time Statistics displays. This interaction can be via a graphical user interface, or the user interface can employ a non-visible display (e.g., a speaker) or input device (e.g., a microphone).

### CROSS REFERENCE TO RELATED APPLICATION

This application claims the benefit of U.S. Provisional Application Ser. No. 61/321,064, filed Apr. 5, 2010, herein incorporated by reference.

### BACKGROUND OF THE INVENTION

The invention pertains to test and measurement instruments and more particularly to the triggering of data capture in such instruments.

Historically, Logic Analyzers have been considered “single shot” instruments. That is, Logic Analyzers capture from several signals to several hundreds of signals, evaluating potential events as “triggers.” Upon determination of a valid trigger, the Logic Analyzer stores the acquired data into a working memory for post process analysis, display, and reporting.

Over the years, the types of events which may be used to trigger a Logic Analyzer have evolved. Triggering on a single bit, whether it was 0 or 1, led to triggering on transitions between bit states, then to multiple bits (words), to triggering on entire strings of bits that make up the fields of packets in serial streams, and eventually to triggering on the entire packets themselves.

The method of defining a trigger in a Logic Analyzer has not changed substantially for the past 12 years; a user creates a “state machine” using Boolean constructs in a user interface.

There are several existing approaches to triggering a Logic Analyzer, or the like. For example, FIG. 1A shows Recording Options (Trigger definition screen), as known from a prior art LeCroy CATC Protocol Analyzer instrument.

The LeCroy CATC Protocol Analyzer (PA) instrument provides an assortment of trigger options based on the content of the serial stream (in this case PCI Express). Note, for example, the ability to trigger on any DLLP, or any one of the specific DLLPs (as indicated by the cascading menu).

A DLLP (or TLP, Ordered Set, and the like) is a specific pattern of bits prescribed by the protocol specification. Each protocol defines the pattern in its specification, and a PA designed to analyze the protocol has the same pattern recognition rules built into the instrument.

FIG. 1B shows a Trigger Graphical User Interface (GUI) display from a prior art Tektronix Logic Analyzer (TLA). Similarly, the TLA permits trigger constructs based on protocol elements. As shown in FIG. 1B, the TLA Trigger GUI provides the user with the means for selecting protocol elements as part of a trigger definition process.

In any case, regardless of the instrument or the instrument manufacturer, currently users are required to build a trigger in an area of the UI (user interface) dedicated to trigger definition and removed from the actual data.

When the acquired data is not a specific element, but instead a statistical value, the user must define a trigger with counters, loop statements, and other complexities that are likely not intuitive. For some cases of statistical triggers, trigger state-machine style interfaces may prevent users from defining appropriate definitions altogether.

FIG. 1C shows a Real Time Statistics display as known from the above-mentioned prior art LeCroy CATC Protocol Analyzer.

As FIG. 1C suggests, Protocol Analyzers provide several different types of statistical measures of the data as it is flowing through the circuit. These are not single-shot acquisitions; they are constantly-updated analyses of protocol-specific data elements and/or structures. For example, Link utilization indicates how much of the theoretical bandwidth is being used at any given moment.

This invention also relates to real-time spectrum analyzers with the capability to acquire and analyze data in real-time. One current use of this real-time analysis capability is for trigger generation to aid in signal capture. Examples are frequency mask trigger, DPX trigger, and RF signature trigger. Several spectrum analyzers on the market have a frequency mask trigger and/or DPX trigger, such as Tektronix RSA3000, RSA5000 and RSA6000 series real-time spectrum analyzers.

The Tektronix analyzers listed above are “real-time” analyzers that capture seamless blocks of data for analysis. Additionally, in some cases the analysis can also be performed in “real-time” without missing any information. Unlike conventional swept analyzers, no data is missed or lost in this seamless capture and analysis process. For use cases involving spectrum monitoring (surveillance, transmitter performance monitoring, etc.) capturing data for analysis is of high importance. This includes not only the capability for capturing seamless data records, but perhaps more importantly the capability for capturing the “right” data. That is, the information of utmost interest in the particular monitoring application. This often requires sophisticated, real-time triggers that can monitor signals and determine when to capture based on desired signal characteristics, or changes in expected characteristics. Traditionally, the signal characteristics monitored for determining triggers have included power level, frequency profile (frequency mask trigger), time/frequency signature, and more recently signal density within a frequency and power range (DPX trigger).

### SUMMARY OF THE INVENTION

The invention is a system and method for defining a trigger for a test and measurement instrument from real time statistics of a data stream.

No logic analyzer, spectrum analyzer or other test and measurement instrument is known to have used real-time statistical processes as a basis for creating a trigger. Protocol analyzers, while providing real time statistic capture do not provide Graphical User Interface (GUI) based statistical triggering.

One aspect of the invention is a method for defining a trigger for a test and measurement instrument for analysis of data in a data stream from a statistic of the data stream. Briefly, the method comprises detecting the data stream; determining a statistic of the data stream in real time, and presenting the real time statistic in a statistical presentation. Then, a selection is received indicating a portion of the real time statistic presented in the statistical presentation. In response, the instrument generates a trigger using the indicated portion of the real time statistic. “Generating” means specifying and assembling in the instrument a particular set of trigger parameters.

The method may optionally include also presenting data from the data stream in a data presentation, which can be triggered based on the indicated portion of the real time statistic. “Portion” refers broadly to a selected subset, feature or entirety of the real time statistical data. The data stream can include multiple data streams, any of which can be captured based on the statistical trigger regardless of which data was the basis for the statistical data.

Another aspect of the invention is a test and measurement instrument, comprising a test or measurement transducer; a module coupled to the transducer to capture a data stream based on a probed signal responsive to a trigger signal; a statistical measurement device coupled to the transducer to generate and transmit a statistic of the data stream in real time, and a processor coupled to a display operative to present a statistical presentation of the real time statistic. The instrument further includes a user operable device for making selections in the statistical presentation, and a trigger responsive to a selection in the statistical presentation to initiate a trigger signal on the data stream. The instrument may further include a data presentation for displaying a selected feature of the data stream responsive to the trigger.

A further aspect of the invention is a user interface for a user to select triggering of a test and measurement instrument for analysis of data in a data stream based on a statistic of the data stream measured in real time, the user interface comprising means for presenting the real time statistic in a statistical presentation; means for receiving a user selection indicating a portion of the real time statistic presented in the statistical presentation; and means for generating a trigger for a portion of the data stream based on the indicated portion of the real time statistic. Advantageously, the user interface can be a graphical user interface. The display and user interface can also be nongraphical. For example, the display can be a non-visible presentation and the user input can be non-visible, such as a speaker and microphone. Alternatively, the display and user interface can include an interface to/from another machine.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1A shows a Trigger Definition Screen as known from the prior art.

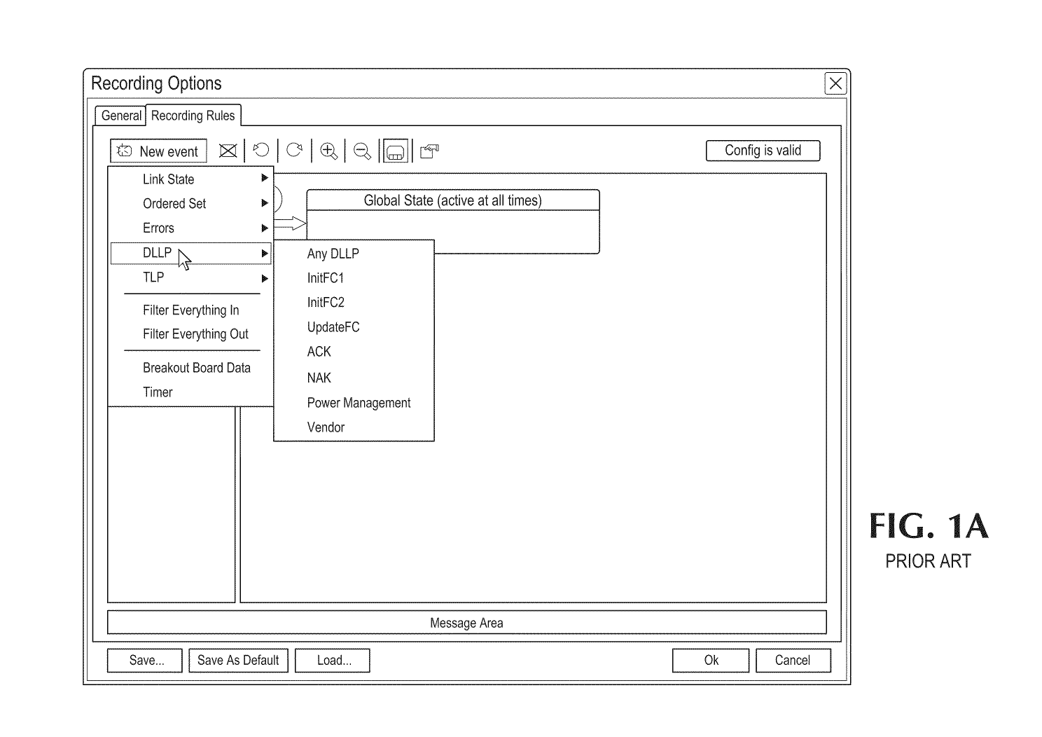

FIG. 1B shows a Trigger Graphical User Interface Screen in accordance with the prior art.

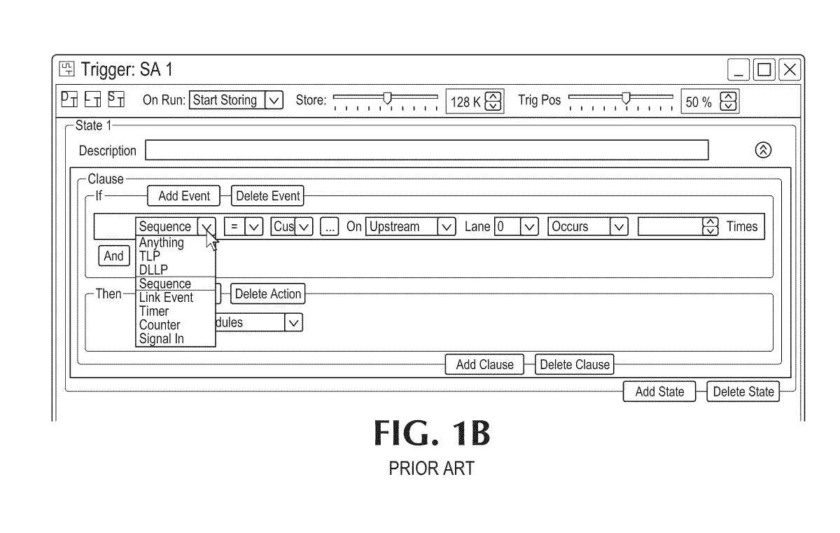

FIG. 1C shows a Real Time Statistics display as known from the prior art.

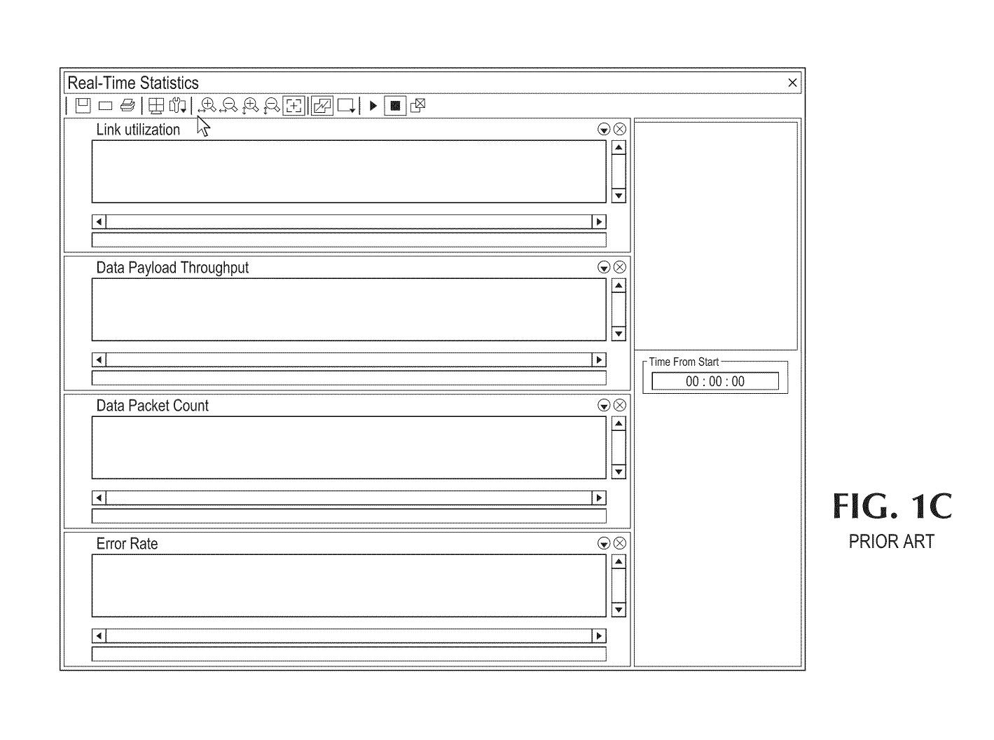

FIG. 2 is a block diagram of an example test and measurement instrument in which an embodiment of the invention is implemented.

FIG. 3 is a flow chart of a method of real time statistical triggering in accordance with the subject invention.

FIG. 4A shows an example of a Real Time Statistics display in accordance with the subject invention showing time-variant statistics.

FIG. 4B shows another example of a Real Time Statistics display in the form of a scatter plot.

FIG. 5 shows an example of Real Time Statistical Triggering in accordance with the subject invention.

FIGS. 6-11 show displays of example real-time statistical waveforms with different examples of graphical triggers useful in an embodiment of the invention.

FIG. 12 shows a typical real-time spectrum analyzer with system real-time trigger processing in accordance with another embodiment of the invention.

FIG. 13 shows a CCDF trigger operating point as defined by a rectangle encompassing the power level and probability range of interest in the embodiment of FIG. 12.

FIG. 14 shows an example of a count of samples received at the power level represented by each power bin collected for use in calculating the CCDF curve of FIG. 1B.

FIG. 15 shows a procedure for the calculation of CCDF directly from signal samples in acquisition memory.

FIG. 16 shows a procedure for the calculation of CCDF by directly tracking power level count indexes.

FIG. 17 shows a procedure for the calculation of CCDF using a decay buffer.

### DETAILED DESCRIPTION

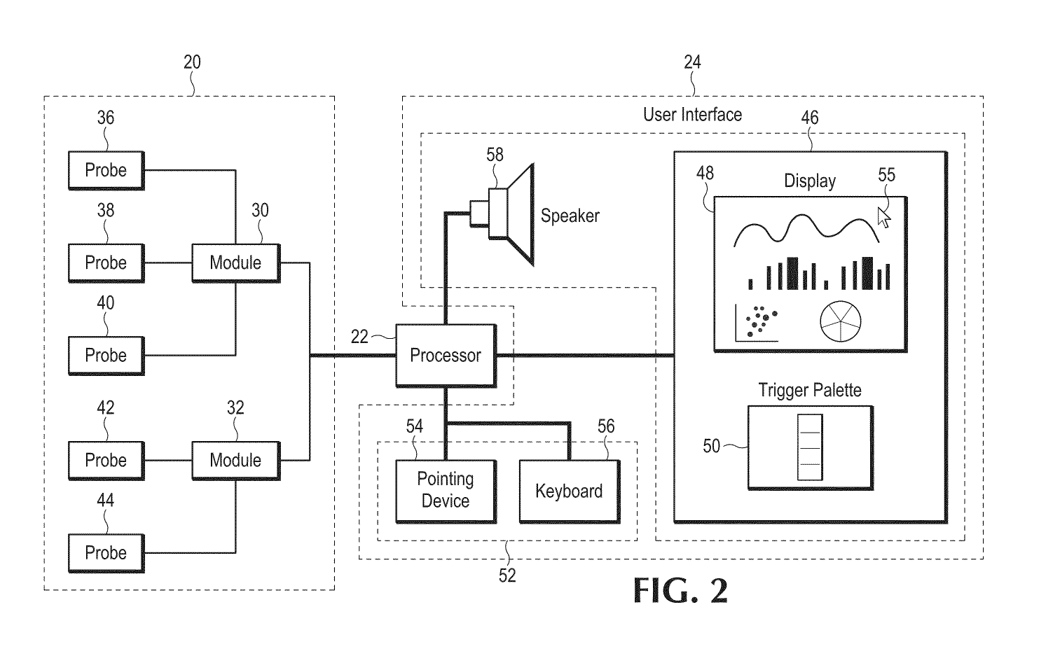

FIG. 2 is a block diagram illustrating a system for analyzing data with an example of a user interface for triggering from a Real Time Statistics (RTS) presentation according to an embodiment of the invention. In this embodiment, the system includes an acquisition system 20, a processor 22 and a user interface 24. The acquisition system 20 is configured to acquire data. Any type of data can be acquired by the acquisition system 20. For example, the acquisition system 20 can include digitizers to convert electrical signals into digitized data. The acquisition system 20 can also include microphones, accelerometers, or any other sensor, transducer, or the like that can convert a physical phenomenon into acquired data.

The acquisition system 20 can acquire data in any medium. For example, electrical signals, optical signals, audible signals, or the like can all be acquired by the acquisition system 20. The acquisition system 20 can acquire data from one or more sources. For example, the acquisition system 20 can be a single probe. In another example, as shown, the acquisition system 20 can be multiple modules 30, 32 each with multiple transducers or probes 36-44. Furthermore, the acquisition system 20 can be an interface for a storage system (not shown). For example, to acquire the data, the acquisition system 20 can read a file from the storage system. An interface for any storage system can be used. For example, the storage system can be a local storage system, a remote storage system, a network attached storage system, a distributed storage system, or the like.

The processor 22 can be a variety of devices. Such devices include general purpose processors, special purpose processors, application specific integrated circuits, programmable logic devices, distributed computing systems, or the like. In addition, the processor 22 may be any combination of such devices.

The processor 22 is configured to present the data from the acquisition system 20 through the user interface 24. The user interface 24 includes a display 46 providing a statistical presentation 48 to present the statistical data, and a trigger palette 50 to create a trigger. The display can also include a visible data presentation, for example, as described in the incorporated patent applications.

The user interface 24 encompasses the devices, apparatuses, systems, or the like that handle interactions between the system and the user. Accordingly, the user interface 24 can include a variety of interfaces. The user interface 24 can include input devices 52 such as knobs, microphones, sensors, dials, sliders, pointing devices 54, 55, keyboards 56, keypad, touch screens, or the like. The display part of the user interface 24 can also include output devices such as displays 46, monitors, speakers 58, mechanical actuators, or the like. Furthermore, such input and output devices can, but need not exclusively be for input or output. For example, the touch screen can be both an input and output device. In another example, a network interface can both receive and transmit inputs and outputs from a user.

Although the user interface 24 includes the term “user,” a user can, but need not be limited to a human being. For example, the user can be an automated process that is using the system. Although a statistical and a data presentation have been described with reference to senses of a human being, either of these presentations can be in a machine readable presentation. For example, the data presentation need not be in a visual, tactile, or audible format, but can be presented in electronic signals or other format suitable for an automated process.

The data presentation is configured to present the data, for example, as described in U.S. Pat. No. 7,827,209 or in U.S. patent application Ser. No. 12/611,302. The implementation of the data presentation can vary depending on the data acquired by the acquisition system. The data presentation can be a visual presentation of the data. For example, electrical signals can be presented as plots on a graph displayed on a monitor 46. The data presentation can also be an audible presentation. For example, the data presentation can be sounds presented through a speaker 58. Although a variety of media for the data presentation have been described, the data presentation can, but need not present the data in the same medium from which it was acquired.

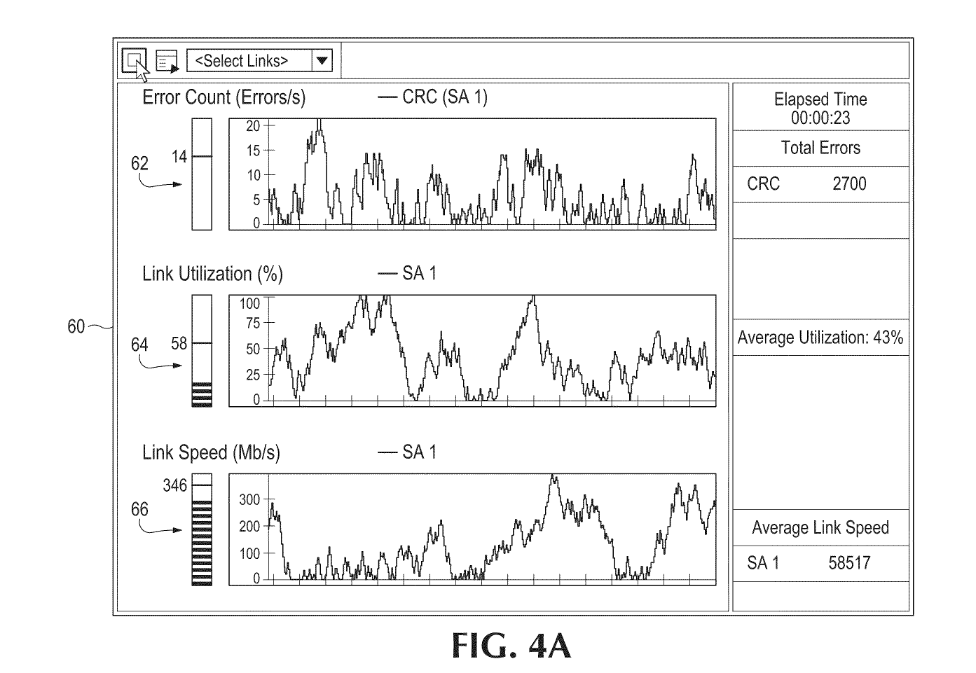

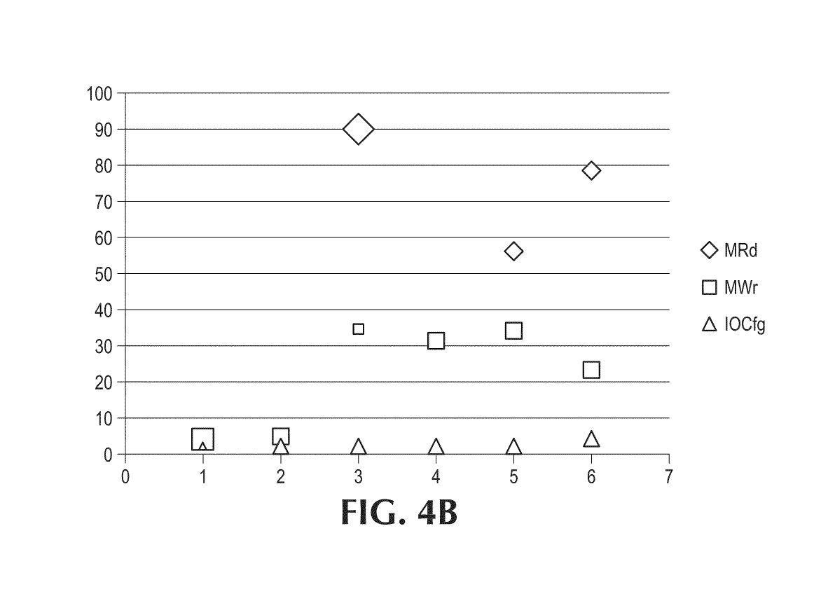

The statistical display 48 presents one or more statistical measures in real time of the data to the user. The trigger palette 50 or menu contains multiple symbols that represent a variety of criteria that can be applied to one or more of the statistical presentations to generate a trigger on the data stream when a selected criterion is met. Specific examples of both statistical measures and of triggers are described below with reference to FIGS. 4-11.

In an embodiment, the processor 22 can be the sole controller of the user interface 24. For example, the processor 22 can receive an input from buttons, pointing devices, keyboards, or the like in the user interface 24 and control a display to present the data presentation. In another embodiment, each aspect of the user interface 24 can have its own processor. Any operation can be distributed across one or more processors in the system.

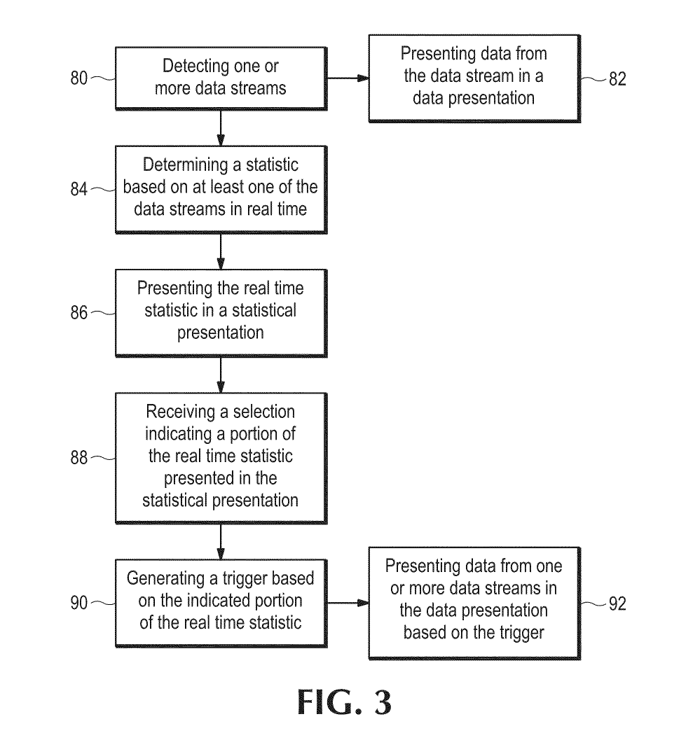

Software programs running on the processor(s) can implement the method of the present invention as described below with reference to FIG. 3. First, however, examples of the RTS interface are described with reference to FIGS. 4-11.

FIG. 4A shows a Real Time Statistics (RTS) display in accordance with an example of the subject invention.

Historically, the logic analyzer displayed basic statistical analyses of data acquired either by single shot, or acquired repetitively. RTS, according to the subject invention, may include a running total of various data elements, the percentage of bandwidth used, frequency of errors and so forth. Displays may be tabular or graphic charts.

The Tektronix TLA7000-series Logic Analyzer has recently entered into the protocol analysis arena, and has created new information visualizations of various protocol elements, such as physical layer symbols, packet structures, and entire transactions among the agents. One such visualization is the presentation of Real Time Statistics (RTS).

A Logic Analyzer according to the subject invention provides a set of Real Time Statistics (RTS) charts as indicated in FIG. 4A. Similar to a LeCroy CATC, Protocol Analyzer instrument, the RTS charts provide information in near real time about data elements as they are flowing through the circuit, without requiring an acquisition in the typical Logic Analyzer fashion. That is, none of the acquired data is stored in the Logic Analyzer, except for the ability to log the statistics to a text file.

Advantageously, apparatus according to this invention can use statistical displays within a Logic Analyzer (LA) or other instrument to define a trigger, based on the selected statistical event itself. In brief, the invention is a Real Time Statistical trigger established by the user through a direct interaction with the Real Time Statistics displays.

Commonly-assigned U.S. Pat. No. 7,827,209, issued 2 Nov. 2010, entitled, Object Based Data Analysis (Frishberg, et al.) shows that a representation of data is used as the basis for creating a trigger definition, incorporated by reference.

Commonly-assigned U.S. patent application Ser. No. 12/611,302, Graphic Actuation of Test and Measurement Triggers (Engholm, et. al.,) shows a trigger definition that is established in the context of the data, incorporated by reference.

This invention differs from these other applications in three ways:

the RTS data itself is not being manipulated (as an object) but rather is used as the background or foundation for the trigger definition (unlike U.S. Pat. No. 7,827,209);

the RTS data is statistical in nature and not a specific data element in a stream of serial data (unlike either of the other inventions);

the RTS data is not removed from its context into a separate “sandbox”, but instead the trigger definitions are applied directly to the statistical readouts (unlike U.S. Pat. No. 7,827,209).

Having distinguished the invention from those disclosed in the above-referenced applications, however, does not preclude the use of the present invention in combination with the foregoing inventions.

A novel aspect of the subject invention is building on the RTS display as a means of defining the TLA trigger. FIG. 4A shows an example of the RTS display 60, which may appear in an instrument along with a data presentation display such as shown in the incorporated patents.

Statistical display 60 contains three examples of statistics of a data stream in real time: Error Count 62, Link Utilization 64, and Link Speed 66. Other kinds of statistics not limited to time trend data may similarly be presented and employed in the present invention.

A scatter plot, a pie chart, a histogram are various examples of other types of statistical displays. The statistics can be as varied as the user demands: how many reads from this specific address or range of addresses as correlated with some other variable; how many types of a specific packet; the average time between one packet initiating and a different packet initiating . . . the list is wide open.

In the scatter plot example shown in FIG. 4B, the user is interested in the correlation between the start time of a transaction (the X-axis) and the length of time the transaction took to complete (latency) the Y-axis. This example combines several different ideas into one, so the explanation is a bit complicated, but it is a scatter plot in any event.

The Y-axis represents the unit of time associated with the transaction latency. The X-axis displays slices of time when one or more transactions were counted. (That is the first idea.) In any given slice, the quantity of transactions depends on the data flowing at that time. Hence, the dots can be shown larger or smaller based on the number of transactions that initiated in that slice. (That is the second idea.) The user may wish to see multiple types of transactions at once, thus the system can show multiple icons, one for each type of transaction. (That is the third idea, and is further described in commonly-assigned U.S. patent application Ser. No. 11/612,639, Symbolic Representation of Protocol-Specific Information (Frishberg, et al.).)

Rather than requiring the user to switch context and define a trigger using a separate trigger state machine, this invention permits the user to establish a trigger directly within the statistical display itself, using the display as a graphical interface. In the FIG. 4B case, one could use a trendline in the depicted statistical data as a trigger, for example.

Note that in the subject apparatus, the user interface is separate from the data and dedicated to the creation of the trigger. In creating a trigger definition directly through a graphical interface, the user creates the trigger more quickly, with fewer errors and with greater confidence.

In some cases, the types of triggers the user can create using the graphical interface would otherwise be very difficult (if not impossible) to define.

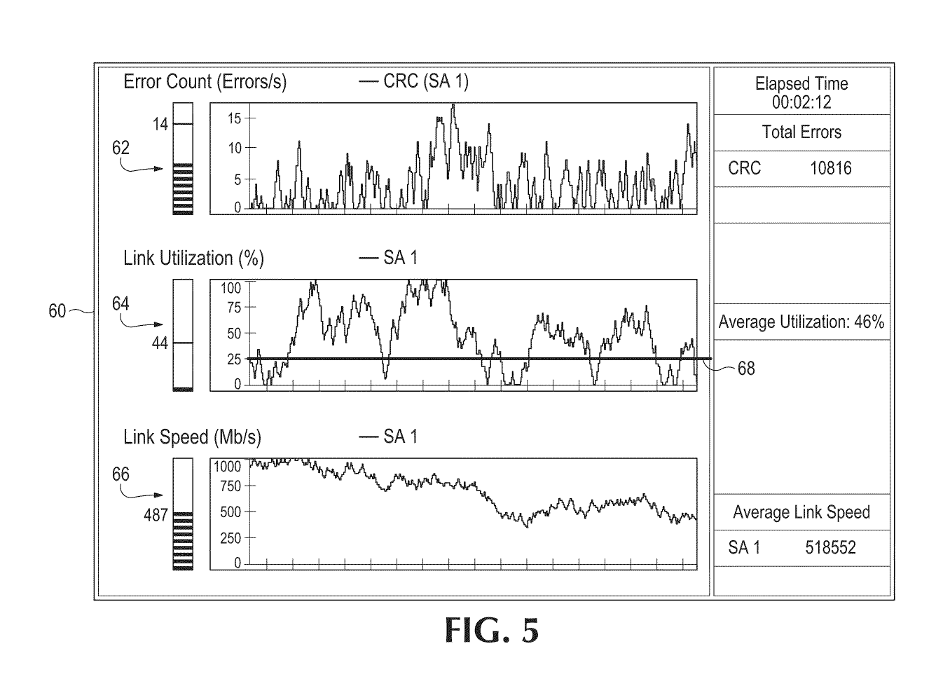

For example, if the test engineer is interested in looking at the bus when Link Utilization 64 has dropped below a certain threshold, she can indicate the desired trigger by simply drawing the trigger threshold on the chart itself, as illustrated in FIG. 5. FIG. 5 shows a Lower Threshold 68 on % of Link Utilization 64.

It is possible to imagine creating this type of trigger using the classical state machine style trigger definition (assign a counter to the threshold event and trigger when the counter reaches a particular value) but that assumes the threshold event is a simple trigger resource that can be counted. In this particular instance (Link Utilization) the threshold event may require several separate resources with several different trigger states just to track, calculate and compare.

In contrast, this example of the invention requires the user to simply place a line at the cross-over point. The underlying trigger definition software marshals and provisions the necessary resources using techniques known in the art.

Several types of RTS graphical triggers can be imagined requiring only a minor increase in user effort (but with increasingly complex state-machine type definitions): lower and upper threshold, latency (holdoff) of value, duration (filter) of value, curve matching, rates of rise, and combinations of these. Other graphical triggers can be imagined as well (for which the equivalent state-machine definition may be near-impossible to create): tolerances around a threshold or repeating patterns of statistical readouts. Some of these are indicated in the FIGURES described below.

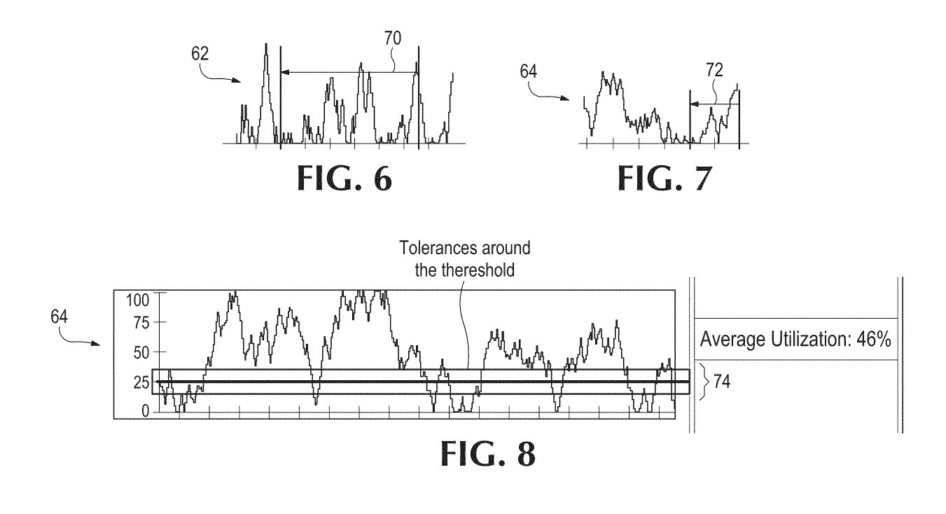

FIG. 6 shows Duration of threshold (“Filter”) 70 in Error Count display 62, wherein a user specifies how long a condition must last before the Logic Analyzer triggers on it.

FIG. 7 shows Latency (“holdoff”) of threshold 72 in Link Utilization display 64 wherein a user specifies how long the Logic Analyzer should delay before triggering on the desired value.

FIG. 8 shows Tolerances of threshold 74 in Link Utilization display 64 wherein a user specifies how much above or below the desired threshold the Logic Analyzer should include in its trigger condition.

FIG. 9 shows Repetitive “Event” 76 in display 62 wherein a user specifies an artifact of the graph that occurs repetitively within a period of time or at a frequency of interest

FIG. 10 shows Rate of rise curve 78 wherein a user specifies a rate of rise (or trend line) for a statistical measure such as Link Speed 66; if the readout conforms to the desired slope, the Logic Analyzer triggers.

FIG. 11 shows curve matching 79 in display 62 wherein a user specifies one of many possible curves that the statistics must match for a trigger to occur.

Graphically defined triggers are limited by the trigger resources in the processor of the Logic Analyzer. As part of the user interface, the trigger definition UI would allow the user to create only those definitions that can be supported by the available resources.

### Operation

In a test and measurement instrument for analysis of data in a data stream, the method of operation as shown in FIG. 3 generally begins by detecting the data stream of a device or system under test by means of probes or other forms of transducers. The data stream can be analog or digital signals, and conventional test and measurement instruments include circuits for triggering on the probed signals to detect, and optionally to capture, some portion or feature of the signals. This step is shown in block 80. Conventionally, and optionally, the data or signals forming the data stream or a portion thereof can be shown in a data presentation, as in block 82.

In accordance with the invention, block 84 calls for determining a statistic of the data stream in real time. The kinds of statistics can vary widely depending on the kinds of data or signals that are being detected. The real time statistic or statistics are displayed in a statistical presentation, as stated in block 86. Examples are described above as shown in FIGS. 4A, 4B and 5.

The user then makes a selection indicating a portion of the real time statistic presented in the statistical presentation and the system receives this selection in block 88. This selection may be performed in the graphical user interface by displaying a graphical symbol to the user which the user can apply graphically to the statistical presentation of the real time statistic to make the selection indicating a portion of the real time statistic to generate the trigger. A trigger palette or menu may be provided which presents to the user multiple symbols representing different graphical modes for a user to select and apply to the statistical presentation of the real time statistic to make the selection, examples of which are shown in FIGS. 5-11.

The system responds to this selection in block 90 by generating a trigger based on the indicated portion of the real time statistic. The system may further present data from one or more data streams in the data presentation based on the trigger generated in block 90, as stated in block 92.

The primary concept of a further embodiment of the invention described next is to extend the use of the real-time trigger to support triggers based on signal statistics, in this case the Complementary Cumulative Distribution Function (CCDF). The CCDF trigger is developed from real-time calculation of a CCDF function of the signal being monitored. CCDF is a calculation of the percentage of time a signal spends at or above a given power level expressed in dB relative to the average signal power level. The trigger threshold is specified in a CCDF operating point which is characterized by a range of power levels and probability, conceptually forming a rectangle through which the signal's CCDF curve passes.

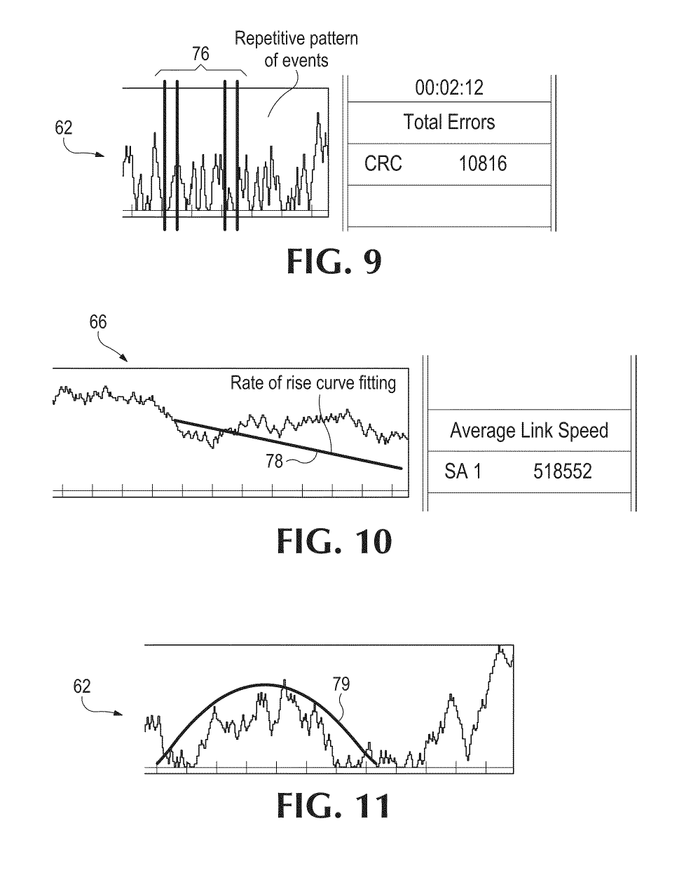

FIG. 12 shows a typical real-time signal acquisition system and the location of the real-time trigger processor where CCDF trigger processing occurs. This example applies the invention to a spectrum analyzer 100.

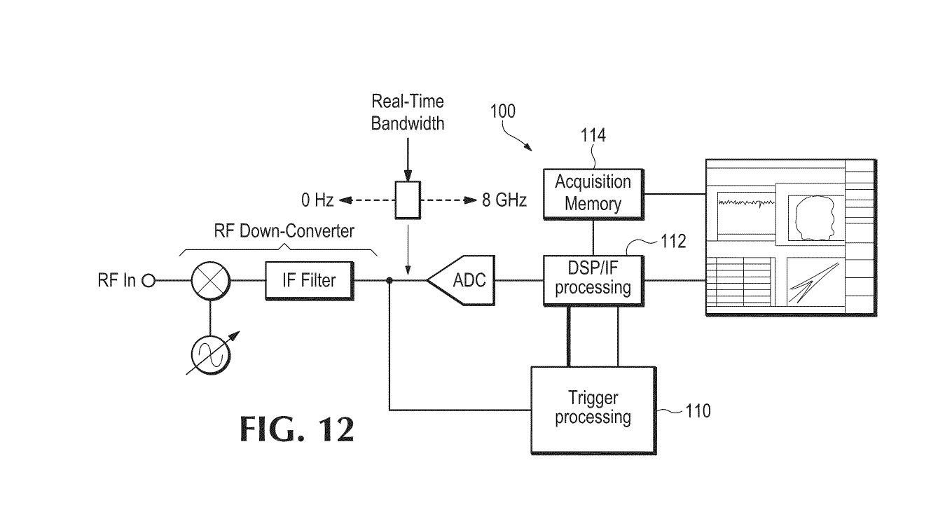

The Trigger Processing block 110 in FIG. 12 receives samples (from the DSP/IF processing block 112) which represent the signal being monitored. The CCDF characteristic is calculated in real-time (i.e., as the samples arrive at the trigger processor) by the Trigger Processor 110. The CCDF trigger is generated conceptually when this CCDF characteristic curve 120 either enters or leaves the operating point 122 for the trigger as shown in FIG. 13. The resulting trigger can be used, for example, to stop data acquisition thus allowing the data collected in acquisition memory 114 to be further analyzed.

The following triggers are also relatively easy extensions to the CCDF trigger:

1) Trigger on CCDF threshold. This is the limiting case of the general CCDF operating point where the CCDF range goes to 0, indicating a CCDF threshold. The trigger is generated when the CCDF characteristic exceeds (or becomes less than) a specific CCDF threshold at a selected power level.

2) Trigger on peak-to-average threshold. Peak-to-average ratio can be easily calculated from the trigger processing described here. A simple threshold value is specified and used to generate a trigger when the peak-to-average value exceeds (or becomes less than) the selected threshold.

The following examples are provided for reference concerning the real-time CCDF calculation. The CCDF characteristic of a signal can be calculated in real-time using a variety of methods. The fundamental operations for calculating CCDF are to 1) track the total count of samples at each power level, and 2) track the oldest (longest surviving sample) so that it can be replaced by a new sample in order to constrain the total population of samples.

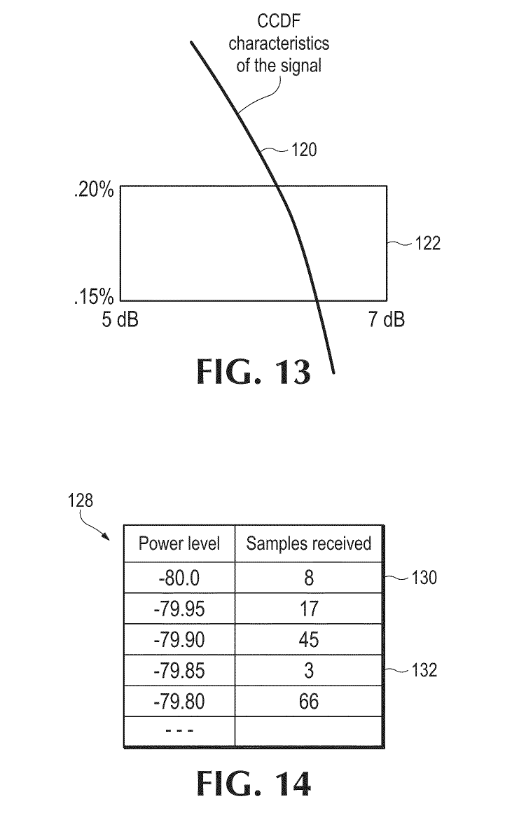

To track the count of samples at each power level the RF signal power range to be monitored can be represented in an array 128 divided into power level bins 130, 132 as shown in FIG. 14. Each power bin represents a specific power level. The number of power bins is chosen to match the desired resolution and memory size requirements. For example, the power range from −80 dBm to −30 dBm can be divided into 1000 power bins each representing (−30−(−80))/1000=0.05 dBm.

The count of samples received at the power level represented by each power bin in array 128 is collected as shown in FIG. 14.

For real-time operation of the trigger, a maximum time range for the collection of power bin count values is required to make a realizable implementation. This time range is determined by the required resolution and memory limitations.

In operation, a charging time (trigger arming time) is required to fill the power bin memory in FIG. 14. After the trigger is armed, each new sample replaces the oldest sample in the collection. That is, the count of the power bin represented by the new sample is incremented and that represented by the oldest sample is decremented.

A CCDF curve can be calculated from the power bins represented in FIG. 14. Each point on the CCDF curve 120 represents the percentage of time a signal spends at or above a given power level (see FIG. 13). The power level is expressed in dB relative to the average signal power level. The CCDF curve is calculated by determining the average power and integrating the power bins over a given operating point for the trigger.

A variety of real-time methods can be used to calculate CCDF. A few such methods are described below.

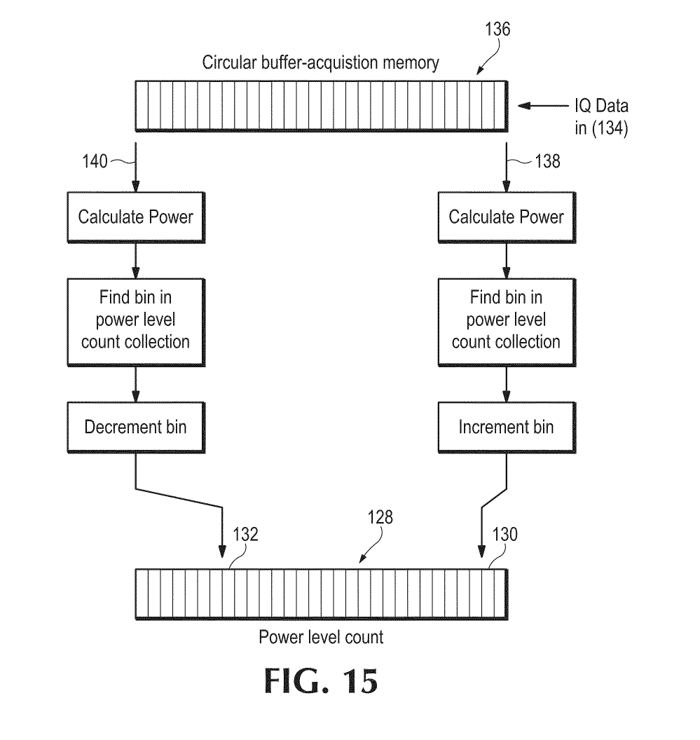

In FIG. 15, IQ samples 134 of the signal are placed into “acquisition memory” represented by a circular buffer 136. The head and tail of this buffer are maintained as part of the acquisition memory 114 (See FIG. 12) as shown by the circular buffer pointers 138, 140. The power level of each new sample is calculated and associated with a bin 130, 132 in the power level count array (see FIG. 14). The associated bin 130 is incremented to track the count. The power level of the sample at the tail is also calculated and the associated power count bin 132 is decremented. This method can be efficient if the head and tail pointers 138, 140 for acquisition memory 114 are available.

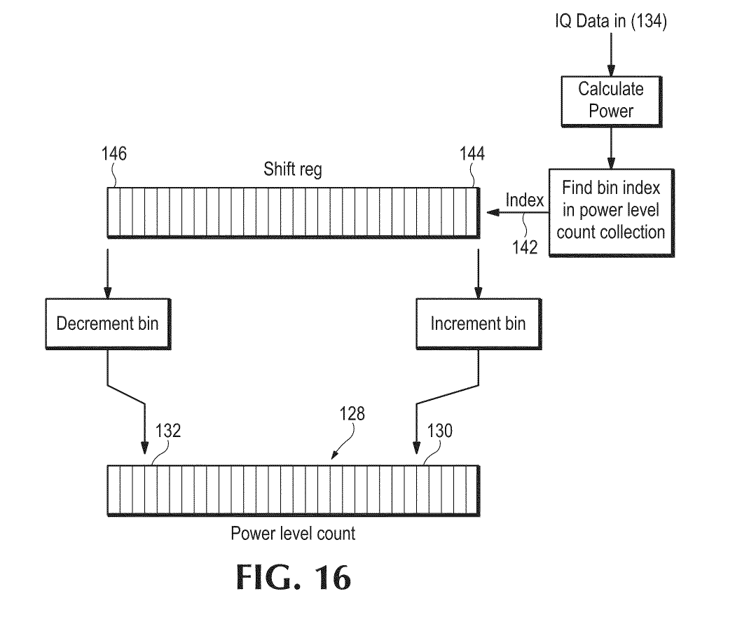

When a buffer of IQ samples is not available to the trigger processor, CCDF can be calculated as shown in FIG. 16. The power level of the new sample 134 is calculated and the index 142 of the associated bin 130 in the power level count array (as in FIG. 14) is determined. This index 142 is used to increment the bin 130 in the power level count array and is also added to the shift register 144. The index at the end 146 of the shift register (the oldest index) is used to decrement the associated bin 132 in the power level count array 128.

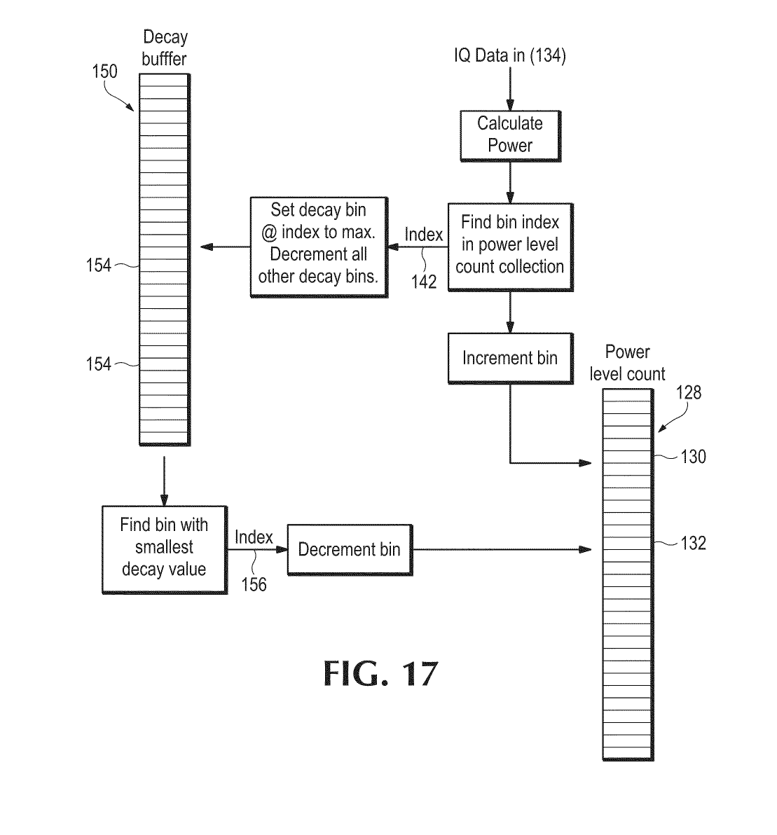

In FIG. 17, a decay buffer 150 equal in size to the power level count array is used to track the oldest sample in the collection. The power level of the new sample 134 is used to find the index into the power level count array associated with that power level. This index is used to increment the count bin 130. The index 142 is also used to set the value of the associated bin 152 in the decay buffer to its max value (thus representing that power level as the newest). All other bins in the decay buffer are decremented. Now, the index 156 of the smallest value 154 in the decay buffer represents the oldest power level. This index 156 is used to decrement the count bin 132 in the power level count.

Having described and illustrated the principles of the invention in various embodiments thereof, it should be apparent that the invention can be modified in arrangement and detail without departing from such principles. We claim all modifications and variations coming within the spirit and scope of the following claims.

1. A method for triggering a test and measurement instrument for analysis of data in one or more data streams, the method comprising:
detecting a data stream;
determining a statistic of the data stream in real time;
presenting the real time statistic in a statistical presentation;
receiving a selection indicating a portion of the real time statistic presented in the statistical presentation; and
generating a trigger for at least one of the data streams based on the indicated portion of the real time statistic.

2. The method of claim 1 further including:
presenting data from the data stream in a data presentation; and
presenting data from one or more of the data streams in the data presentation based on the indicated portion of the real time statistic.

3. The method of claim 1 further including:
presenting multiple real time statistics in a statistical presentation; and
selecting one or more of the multiple real time statistics in which to receive a selection and generate a trigger.

4. The method of claim 1 in which the user graphically selects a feature of the real time statistic in the statistical presentation.

5. The method of claim 1 further including displaying a graphical symbol to the user which the user can apply graphically to the statistical presentation of the real time statistic to make the selection indicating a portion of the real time statistic to generate the trigger.

6. The method of claim 1 further including displaying a trigger palette which presents to the user multiple symbols representing different graphical modes for a user to select and apply to the statistical presentation of the real time statistic to make the selection indicating a portion of the real time statistic.

7. A test and measurement instrument, comprising:
a test or measurement transducer;
a module coupled to the transducer to capture one or more data streams based on a probed signal responsive to a trigger signal;
a statistical measurement device coupled to the transducer to generate and transmit a statistic of the data stream in real time;
a processor coupled to a display operative to present a statistical presentation of the real time statistic;
a user operable device for making selections in the statistical presentation; and
a trigger responsive to a selection in the statistical presentation to initiate a trigger signal on the data stream.

8. The test and measurement instrument of claim 7 in which the display includes a user interface responsive to the user operable device for making selections in the statistical presentation.

9. The test and measurement instrument of claim 8 in which the user interface is a graphical user interface.

10. The test and measurement instrument of claim 9 in which the graphical user interface includes a trigger palette displaying multiple symbols that represent various criteria that can be applied to the statistical presentation to generate a trigger when a selected criterion is met.

11. The test and measurement instrument of claim 8 in which the user interface includes a non-graphical means for presenting the statistical presentation.

12. The test and measurement instrument of claim 8 in which the user operable device includes a non-graphical means for making selections.

13. The test and measurement instrument of claim 7 in which the processor includes a processor operative to present a data presentation of the one or more data streams responsive to a trigger.

14. The test and measurement instrument of claim 13 in which the user operable device is also operable for making selections in the data presentation.

15. A user interface for a user to select triggering of a test and measurement instrument for analysis of data in one or more data streams based on a statistic of the one or more data streams measured in real time, the user interface comprising:
means for presenting the real time statistic in a statistical presentation;
means for receiving a user selection indicating a portion of the real time statistic presented in the statistical presentation; and
means for defining a trigger for one or more of the data streams based on the indicated portion of the real time statistic.

16. The user interface of claim 15 further including:
means for presenting multiple real time statistics in a statistical presentation; and
means for selecting one or more of the multiple real time statistics in which to receive a selection and generate a trigger.

17. The user interface of claim 15 including means responsive to a user operable device for the user to designate a portion of the real time statistic to make the user selection.

18. The user interface of claim 17 in which the means for presenting and means for receiving are operable as a graphical user interface.

19. The graphical user interface of claim 18 further including means for visibly displaying a graphical symbol to the user which the user can apply graphically to the statistical presentation of the real time statistic to make the selection indicating a portion of the real time statistic to generate the trigger.

20. The graphical user interface of claim 18 further including means for visibly displaying a trigger palette which presents to the user multiple symbols representing different graphical criteria for a user to select and apply to the statistical presentation of the real time statistic to make the selection indicating a portion of the real time statistic.

21. The user interface of claim 15 in which the means for presenting includes means for non-visibly presenting the real time statistic.

22. The user interface of claim 15 in which the means for receiving is operable to receive a non-visible user selection.
